(19) United States
(12) Patent Application Publication
(10) Pub. No.: US 2008/0000756 A1
(43) Pub. Date: Jan. 3, 2008

(54) High speed linear pick-and-place

(76) Inventors: Merlin E. Behnke, Mequon, WI (US); Rob G. Bertz, Wauwatosa, WI (US); Duane B. Jahnke, Hartford, WI (US); Todd K. Pichler, New Berlin, WI (US); Ken J. Pikus, New Berlin, WI (US); Mike J. Reilly, Mukwonago, WI (US); Dave J. Rollmann, New Berlin, WI (US); Mark R. Shires, Glendale, WI (US)

Correspondence Address: Mark Shires;International Product Tech., 3100 S. 166th St., New Berlin, WI, 53151, US

(21) Appl. No.: 11/823,745

(22) Filed: Jun. 28, 2007

Related U.S. Application Data
(60) Provisional application No. 60/818,048, filed on Jun. 30, 2006.

(51) Int. Cl. B65G 47/91

(52) U.S. Cl. 198/468.4; 294/65; 414/752.1

(57) ABSTRACT

A high-speed linear pick-and-place for increasing the speed of transfer of semiconductor electronic devices with accommodation for automated inspection or test. The invention includes two or more linear pick-and-place assemblies, each having two or more independently positionable pick-and-place nozzles. These assemblies are aligned such that the 4 or more nozzles can all pick and place to common shared locations. The 4 or more nozzles are operated so that they can pass by each other on their return stroke, except that nozzles sharing a rail cannot pass each other.

### CROSS REFERENCE TO RELATED APPLICATIONS

This application claims the benefit of provisional patent application Ser. No. 60/818,048 filed Jun. 30, 2006, by the present inventors.

### FEDERALLY SPONSORED RESEARCH

Not Applicable.

### SEQUENCE LISTING OR PROGRAM

Not Applicable.

### BACKGROUND—FIELD OF THE INVENTION

The present invention relates generally to linear pick-and-places and more specifically it relates to a high-speed linear pick-and-places for increasing the speed of transfer of semiconductor electronic devices with accommodation for automated inspection or test. The invention is a high-speed linear pick-and-place that can continuously feed semiconductor electronic devices to a machine vision inspection system or an electrical tester and consequently place them in at least two different sorted output locations without a substantial degradation of speed regardless of the sorting required.

### BACKGROUND—PRIOR ART

It can be appreciated that linear pick-and-places have been in use for years. A pick-and-place is a parts handling apparatus that can pick up a product from one location and place it down in another location. A linear pick-and-place can move products along a linear path. Typically, high throughput linear pick-and-places are either walking beam type pick-and-places, such as U.S. Pat. No. 5,836,323 which pipelines parts by simultaneously moving many parts an increment at a time toward their destination, or gang type pick-and-places (such as U.S. Pat. Nos. 6,439,631 & 5,575,376) which move many parts simultaneously to their destination in one move.

The main problem with conventional linear pick-and-places is the slow speed, particularly when accommodating inspection or test. The walking beam type pick-and-place has slower product throughput because there is a return stroke after the part is placed, and during this time product doesn't progress forward in the production pipeline. Another problem with the walking beam type pick-and-place is that the device needs to be set down on a surface and then picked up again by another vacuum nozzle. The device can be damaged by setting it down. Also, when device inspection or electrical test is required it is usually best performed with the device on the nozzle, not while set down. Yet inspecting or testing the device on the nozzle further slows down the speed of the walking beam pick-and-place. And finally, cumulative device-to-nozzle positional errors occur with additional handling (picking or placing) which adversely affects the accuracy of ultimate placement of the device into its destination.

The main problem with the gang type pick-and-place is that an array of many electronic devices are moved together and it is difficult to individually present the devices to a machine vision inspection system that needs to see each side of each device, or an electrical tester that requires the device to be individually plunged into a test station. Another problem with the gang type pick-and-place is that the pitch between each pickup nozzle often needs to be changed real-time to adjust to the output media pitch, or non-real-time when preparing the machine to process other electronic devices from different media. Many complicated mechanisms have been designed to deal with this (U.S. Pat. Nos. 7,000,648; 7,023,197; 6,439,631 and many others). Also, sorting the electronic devices often slows down the overall throughput as the gang handler needs to move the entire array of nozzles to locations that only a few nozzles need to access. Employing a plurality of nozzles is also expensive and more difficult to maintain. And finally, stopping the gang pick-and-place for vision inspection or electrical slows down the machine as other devices are not being simultaneously processed.

The pick-and-places of the prior art are not ideally suited to accommodate vision inspection or electrical test and still maintain high speed handling.

### SUMMARY OF THE INVENTION

The present invention is a high-speed linear pick-and-place that can continuously feed semiconductor electronic devices to a machine vision inspection system or an electrical tester and consequently place them in at least two different sorted output locations without a substantial degradation of speed regardless of the sorting required.

To attain this, the present invention comprises two or more linear pick-and-place assemblies, each having two or more subassemblies of independently controllable vacuum pick-and-place nozzles whose movement can be controlled horizontally and vertically and whose vacuum can be controlled. These linear pick-and-place assemblies are aligned such that the 4 (or more) nozzles can all pick from common shared locations and place to other common shared locations. All the pick locations and place locations are on a common centerline. Each subassembly comprises a vacuum nozzle capable of picking up electronic devices via vacuum, a vertical actuator for moving the nozzle vertically, and a horizontal actuator for moving the nozzle horizontally. The nozzles of the assemblies are arranged such that they can pass over or under the nozzles of the opposing assembly to optimize throughput. In normal operation the pairs of nozzles follow each other in a loop or circuit. The exception being if a device needs to be sorted to a different destination module.

The main object of the present invention is to provide a high-speed linear pick-and-place for increasing the speed of transfer of semiconductor electronic devices with accommodation for automated inspection or test.

Another object is to provide a high-speed linear pick-and-place that allows machine vision inspection or electrical test of electronic devices while suspended on the pick-and-place nozzle, thus avoiding possible damage that can occur when a device is set down.

Another object is to provide a high-speed linear pick-and-place that does not significantly diminish handling speed when each electronic device is picked and then temporarily stopped for machine vision inspection or electrical testing. The inspection or test operation does not disrupt the natural process of the pick-and-place. Additionally, the machine vision inspection system or electrical tester can run at nearly 100% duty cycle by continuously feeding the devices at a roughly constant rate and thus optimizing the overall throughput of the machine while maximizing inspection and test time.

Another object is to provide a high-speed linear pick-and-place that allows real-time variable positioning of each nozzle independently in at least height(z) and stroke (x) to better accommodate inspection and test requirements and accurate individual device placement.

Another object is to provide a high-speed linear pick-and-place that handles the electronic device exactly once, picking from the input and placing into the output, to increase the accuracy of placement by eliminating cumulative handling errors, and to minimize possibility of device damage due to placement errors.

Another object is to provide a high-speed linear pick-and-place that can sort electronic devices, placing them in different locations, based on the results of machine vision inspection or electrical test where the handling speed is substantially unaffected by the sorting requirements.

### BRIEF DESCRIPTION OF THE DRAWINGS

FIG. 1 is an isometric view of the invention.

FIG. 2 is an isometric view of half of the invention (one linear pick-and-place assembly).

FIG. 3 is an end view of the invention.

FIG. 4a-4g show front views of the relative locations of the 4 nozzles during various steps in the operation of the invention.

FIG. 5 illustrates a close-up isometric view of another embodiment having retractable vacuum nozzles.

FIG. 6 illustrates a close-up isometric view of another embodiment having pivoting vacuum nozzles.

### DETAILED DESCRIPTION OF THE INVENTION

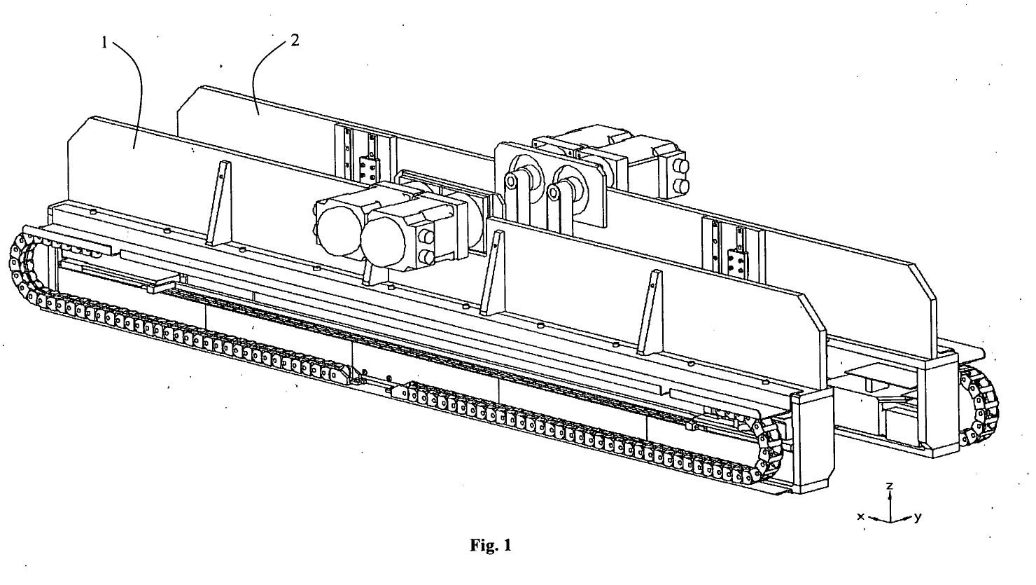

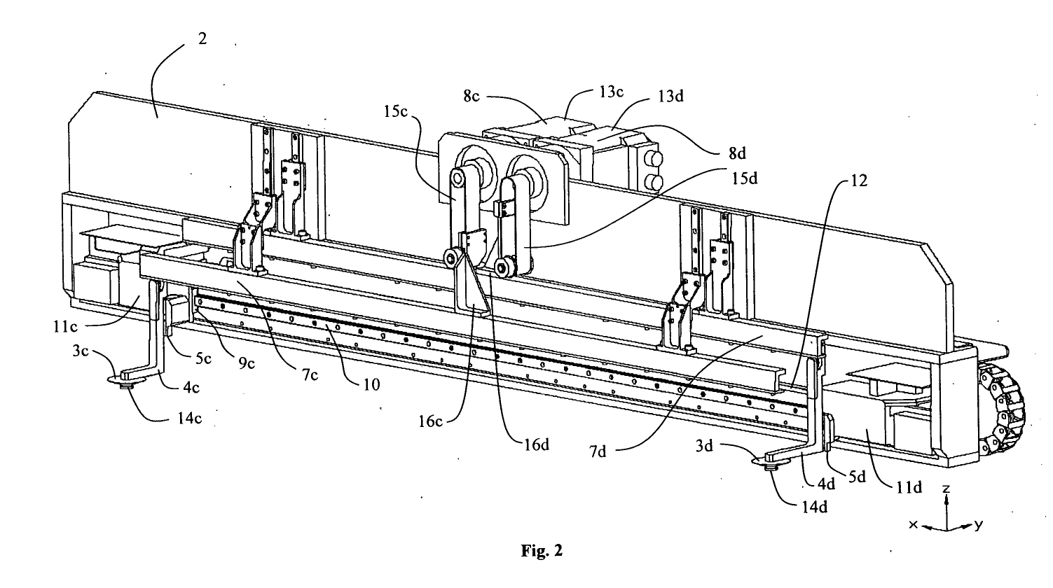

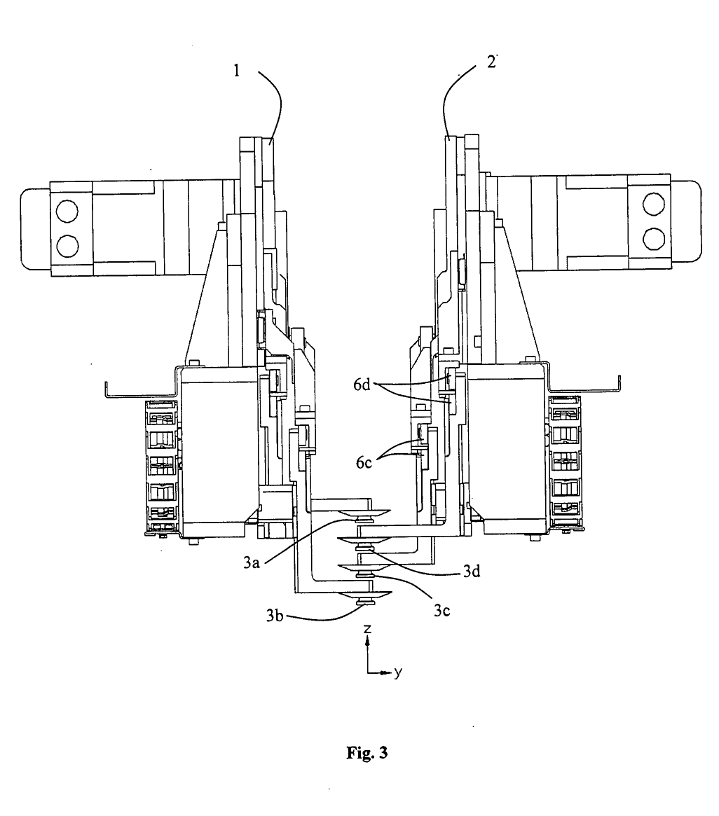

FIG. 1 illustrates the invention which comprises two identical linear pick-and-place assemblies 1 and 2. For clarity, FIG. 3 shows just linear pick-and-place assembly 2. The assembly has two subassemblies with independently positionable (in height (z) and horizontally (x)) vacuum pick-and-place nozzles 3c and 3d. The two assemblies are positioned (see FIG. 3) so that all 4 nozzles 3a, 3b, 3c, and 3d can all pick from common shared locations and place to other common shared locations and where all these locations share a common centerline. FIG. 3 shows the 4 nozzles at different heights. All the nozzles move in the same plane. Referring now to FIG. 2, each vacuum nozzle 3c and 3d has a surface 14c and 14d that contacts the electrical device. This surface has a hole to allow air to flow through. This hole is at times evacuated so that the device can be sucked onto the nozzle. Each nozzle is connected to an arm 4c and 4d which is connected to a dedicated vertical bearing 5c and 5d which allows the nozzle to move vertically. Rollers 6c and 6d (see FIG. 3) on the arm roll along a horizontal lift bar 7c and 7d. Dedicated electric servomotors 8c and 8d, can move the lift bars vertically by means of a belts 15c and 15d and mechanical linkage 16c and 16d, and thus move the respective nozzle vertically to a variety of heights while the nozzle is in any horizontal location along the linear pick-and-place. Each nozzle subassembly has its own horizontal slide 9c and 9d (not visible) that slides along a common horizontal rail 10 shared by at least one more nozzle subassemblies. Dedicated horizontal actuators 11c and 11d, in this case linear electric motors, independently move the nozzles to a variety of horizontal positions. Horizontal encoder readers reside in motors 11c and 11d and read encoder scale 12 to provide positional information as to the horizontal location of each nozzle. Vertical positional information about each nozzle is acquired thru rotary encoders 13c and 13d. The 4 nozzles are operated so that they can pass over or under each other on their return stroke (i.e. when returning to pick up a part), except that nozzles sharing a rail cannot pass each other. With this mechanism and in this method of operation the pick-and-place can operate so that parts are continuously moved toward their destination.

Each vacuum nozzle has a surface that contacts the electrical device. It has a hole bored in the center of this surface to allow air to flow through. There is a fitting on the opposite end of the hole to attach an air line to. The nozzle is typically metallic, but sometimes it is made of a pliable material to create a better vacuum seal with the part. The nozzle depicted has a cone shaped illuminating surface so that when it is illuminated with light during inspection, an electronic device on the nozzle is backlit as viewed by a camera below. The shape and material of the vacuum nozzle can vary. The nozzle could be replaced with another pickup or device handling means such as a robotic claw.

Each vertical bearing allows the nozzle to move vertically. The vertical bearing is a linear slide. The type of vertical bearing may vary.

Each vertical actuator, in this case an electric servomotor, can lift the nozzle vertically to a variety of heights. Having a stationary vertical actuator that transfers its motion to the nozzle via a lift bar removes substantial weight from the nozzle subassembly as opposed to having the vertical actuator move horizontally with the nozzle. This translates to an increase in speed. The type of vertical actuator may vary. It may be a stepper motor, a solenoid, pneumatic so some other means.

Each lift bar allows the vertical actuator to lift the nozzle while the nozzle is in any horizontal location along the linear pick-and-place. The lift bar is a long bar that extends across the length of the horizontal travel of the nozzle. It is moved up and down by the vertical actuator and consequently lifts the nozzle. The nozzle is attached to the lift bar via some rollers. The shape of the lift bar may vary. The bar may be a rod. The bar could pivot along a horizontal bearing. The bar could even move horizontally and engage a mechanism on the nozzle subassembly that transfers the horizontal motion to vertical motion.

Each horizontal bearing allows the nozzle to move horizontally. One preferred embodiment utilizes a stationary horizontal rail and a slide on each vacuum nozzle subassembly. The type of horizontal bearing may vary. In the preferred embodiment two or more nozzle assemblies share the same horizontal rail so as to move along exactly the same axis.

Each horizontal actuator, a linear electric motor in the embodiment depicted, propels the nozzle to any desired horizontal position not blocked by any other nozzles sharing the common track. The motor has coils and moves along a stationary magnet track. In the preferred embodiment two or more motors share the same linear magnet track. Alternatively the actuator may be a traditional motor with a screw drive or belt or even pneumatically activated. Various actuators would suffice.

Each horizontal encoder provides positional information as to the horizontal location of the nozzle. The horizontal encoder consists of a long stationary flat surface with precision etched optical markings, and a light source and photosensor that are attached to the moving element. When motion occurs the light reflected off the etched marking surface is converted to electrical pulses so that the exact position of the unit can be determined. The encoder could be a magnetic encoder. Various types of other encoders would work also.

Each vertical encoder provides positional information as to the vertical location of the nozzle. The vertical encoder operates on the same principle as the horizontal encoder. The illustrated embodiment however shows a rotary encoder that is attached to the motor shaft. Magnetic encoders or other various types of encoders would work also.

The nozzle is attached to the end of an “L” shaped arm. The arm has this “L” shape so that nozzles on the opposing assembly can pass over or under the nozzles on the present assembly (FIG. 3). The vertical section of this arm is bolted to a short vertical bearing to allow it to move up and down. The vertical bearing is bolted to a linear motor, which is connected to a horizontal slide that can move along a common horizontal rail that is shared by one or more additional independently movable nozzle assemblies. On the top of the “L” shaped arm are wheels that roll along the lift bar so that the present height of the nozzle is determined by the present height of the lift bar. The lift bar is connected to 4 additional vertical bearings so that it can move up and down vertically. The lift bar is also connected to a vertical section of a belt that is moved via a servomotor. The full pick-and-place is created by arranging two assemblies facing each other and aligned so that the 4 nozzles can access the same locations. Additionally increasing the number of nozzles and linear motors on an existing horizontal rail could further increase the overall speed of handling parts. Increasing the number of pick-and-place assemblies that share the same pick and place locations could further increase the overall speed of handling devices.

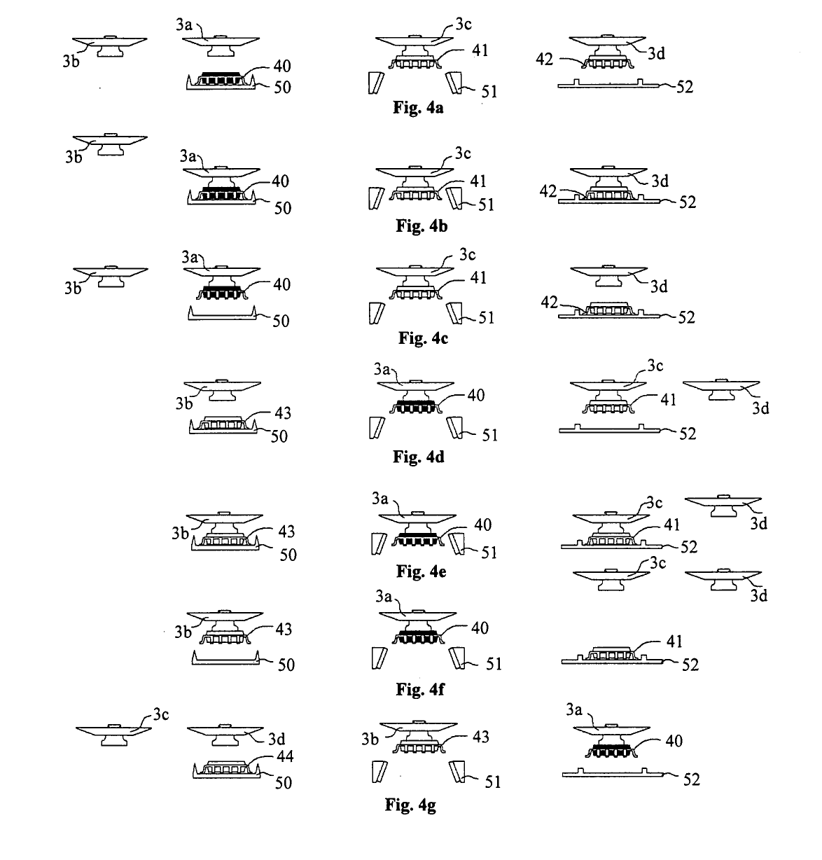

The rear pick-and-place assembly has two nozzles: 3c and 3d. The front Pick-and-place assembly has two nozzles: 3a and 3b. Each nozzle can move independent of the other nozzles as each has its own vertical and horizontal actuators. However, nozzle 3d must always be to the right of nozzle 3c, and nozzle 3a must always be to the right of nozzle 3b due to the mechanical constraints of the system. Care must also be taken to avoid a nozzle crashing into another nozzle. The operation of the system is controlled by an electronic controller such as a computer. During operation the nozzles move as shown in the sequence of FIGS. 4a-4g. Item 50 represents a pocket in a tray that holds electronic devices (such as device 41). Devices are picked from this location and then moved to an inspection or test station 51 and then placed in a final destination 52. FIG. 4a shows the 4 nozzles in-process. All nozzles are in an up position. (Note that nozzle 3a is shown in black for clarity.) FIG. 4b shows the subsequent step in which nozzle 3a has lowered to pick device 40, nozzle 3c has lowered to present device 41 to the tester, and nozzle 3d has lowered to place device 42. FIG. 4c shows that nozzle 3a has moved up with device 40, nozzle 3c moves up with device 41, and nozzle 3d moves up after having placed device 42 in its destination. FIG. 4d shows nozzle 3b has moved into pick position above a new device 43, nozzle 3a has moved above test station 51, nozzle 3c has moved above place station 52, and nozzle 3d has move aside. FIG. 4e shows nozzle 3b in a down position to pick device 43, nozzle 3a is down in test location 51, nozzle 3c is down to place device 41 in its final destination, and nozzle 3d hasn't moved. FIG. 4f shows nozzle 3b having picked device 43, nozzle 3a moves up from test station 51, and nozzle 3c moves up having placed device 41. Finally, FIG. 4g shows nozzles 3c and 3d have passed over the other nozzles and are staged to pick new devices. During this return trip, nozzles 3a and 3b are still moving devices thru the system so time is not wasted. Nozzle 3a has moved over test station 51, and nozzle 3b has moved device 40 over station 52 to place the device in its final location. The nozzles are now exactly halfway thru their cycle and the operation continues in the same manner. Typically the parts are picked and placed in a variety of horizontal locations. The nozzles can follow this same general path even while varying the specific pick, test, and place locations. For example, if after inspection or test the placement point is to the left, nozzles can move up and over the nozzles following them.

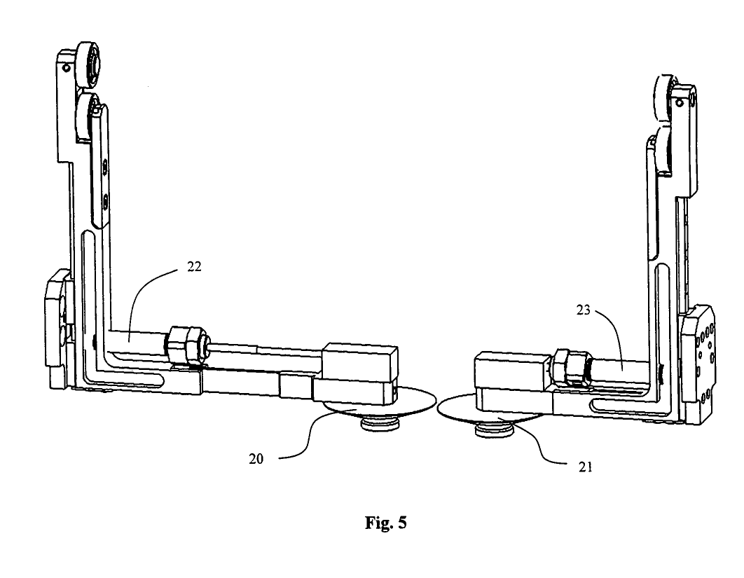

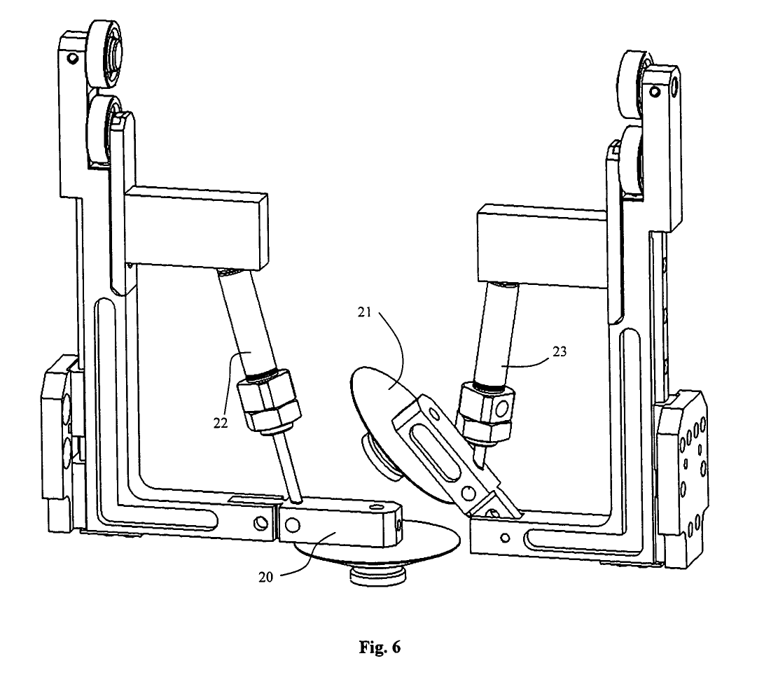

Alternatively the nozzles can be made to pass around each other in the y dimension instead of the z dimension. One such embodiment makes the nozzles retract and extend in the y dimension real-time. FIG. 5 illustrates a close-up side view of a retractable subassembly. The nozzle on the left side 20 is moved in or out via a cylinder 22. The nozzle on the right side 21 is moved in or out via cylinder 23. The actuator could alternatively be electric or another type of actuator. In this case all the nozzles do not move within a single plane. In FIG. 6 nozzle 20 is extended and is in the pick and place plane while nozzle 22 is retracted so as to be able to move around nozzle 20. It can be appreciated that the nozzle could be moved along different angles and still not depart from the spirit and scope of the invention.

Alternatively the “L” shaped arm can hinge so that the nozzles can pass each other by pivoting out each other's of the way. FIG. 6 illustrates a closeup side view of a hinging subassembly. The nozzle on the left side 20 is pivoted up or down via a cylinder 22. The nozzle on the right side 21 is pivoted up and down via cylinder 23. The actuator could alternatively be electric or another type of actuator. In FIG. 6 nozzle 20 is in the pick and place plane while nozzle 22 is pivoted out of the way so as to be able to pass nozzle 20. The hinging could occur along a different axis and still allow the nozzles to pass each other.

It is also possible that the pivoting or extending/retracting could be mechanically linked to the vertical actuation of the nozzle so that the nozzles can pass by each other when vertically lifted.

The core concept of this invention is that 4 or more nozzles can pass around, over, or by each other as they return in their cycle, and having these multiple nozzles move independently (not in gang arrays). Another important concept of this invention is increasing speed by eliminating mass on each nozzle assembly by offloading the vertical actuation.

What is claimed is:

1. A high speed linear pick-and-place for electronic devices, said pick-and-place comprising:
a) two or more pick-and-place assemblies positioned so that devices can be picked from a common location and placed to a different common location, said assemblies comprising two or more subassemblies that can pick devices from a common location and place them to a different common location, said subassemblies comprising:
a) a pickup means that can selectively secure and release an electronic device,
b) a vertical bearing means for allowing said vacuum nozzle to move in a substantially vertical direction,
c) a vertical actuator means to move said vacuum nozzle in a substantially vertical direction,
d) a horizontal bearing means for allowing said vacuum nozzle to move in a substantially horizontal direction,
e) a horizontal actuator means to move said vacuum nozzle in a substantially horizontal direction.
b) an electronic controller means to control said actuators and thus the movement and operation of said pickup means such that said pickup means of one said pick-and-place assembly can pass above or below said pickup means of at least one other said pick-and-place assembly.

2. A high-speed linear pick-and-place of claim 1 wherein the said pickup means of said subassemblies comprise a vacuum nozzle,

3. A high-speed linear pick-and-place of claim 1 wherein the said pickup means of said subassemblies share a common rail that is part of said horizontal bearing means.

4. A high-speed linear pick-and-place of claim 1 wherein said vertical actuator means is stationary and transmits mechanical motion to said pickup means by way of a substantially horizontal bar which can be moved vertically and to which said pickup means is mechanically linked such that the height of said pickup means can be adjusted while said pickup means is in a variety of horizontal locations.

5. A high-speed linear pick-and-place of claim 4 wherein said mechanical linkage includes wheels that contact said horizontal bar and roll on said horizontal bar as said pickup means move horizontally.

6. A high-speed linear pick-and-place of claim 1 wherein said pick-and-place assemblies can pick and place to at least 4 locations that share a common centerline.

7. A high speed linear pick-and-place for semiconductor devices, said pick-and-place comprising:
a) two or more pick-and-place assemblies positioned so that devices can be picked from common locations and placed to different common locations wherein all said locations have a coincident centerline, said assemblies comprising:
a) two or more subassemblies that can pick parts from a common location and place them to a different common location wherein all said locations have a coincident centerline, the subassemblies comprising:
a) a vacuum nozzle means for picking and placing electronic components,
b) a vertical bearing means for allowing said vacuum nozzle to move in a substantially vertical direction,
c) a vertical actuator means to move said vacuum nozzle in a substantially vertical direction,
d) a horizontal actuator means to move said vacuum nozzle in a substantially horizontal direction.
b) a horizontal bearing means that is shared by two or more said subassemblies, such that each subassembly can transverse the horizontal bearing independently but cannot pass each other.
b) an electronic controller means to control said actuators and thus the movement and operation of said vacuum nozzles such that said vacuum nozzles of one said pick-and-place assembly can pass above or below or otherwise around said vacuum nozzles of at least one other said pick-and-place assembly.

8. A high-speed linear pick-and-place of claim 7 wherein horizontal actuator means comprises a linear motor utilizing stationary magnets wherein two or more said subassemblies share common magnets.

9. A high-speed linear pick-and-place of claim 7 wherein said vertical actuator means is stationary and transmits mechanical motion to said vacuum nozzle by way of a substantially horizontal bar which can be moved vertically and to which said vacuum nozzle is linked mechanically such that the height of said vacuum nozzle can be adjusted while said vacuum nozzle is in a variety of horizontal locations.

10. A high-speed linear pick-and-place of claim 9 wherein said mechanical linkage includes wheels that contact said horizontal bar and roll on said horizontal bar as said vacuum nozzles move horizontally.

11. A high speed linear pick-and-place for increasing the speed of transfer of semiconductor electronic devices, said pick-and-place comprising:
a) two or more pick-and-place assemblies positioned to service substantially common collinear locations, the assemblies comprising:
a) two or more subassemblies that service substantially common collinear locations, the subassemblies comprising:
a) a vacuum nozzle means for picking and placing electronic components,
b) a vertical bearing means for allowing said vacuum nozzle to move in a substantially vertical direction,
c) a vertical actuator means to move said vacuum nozzle in a substantially vertical direction,
d) a shared horizontal bearing means for allowing said vacuum nozzle to move in a substantially horizontal direction, wherein said shared horizontal bearing is common for two or more subassemblies,
e) a horizontal actuator means to move said vacuum nozzle in a substantially horizontal direction.
b) an electronic controller means to control said actuators and thus the movement and operation of said vacuum nozzles such that said vacuum nozzles of one said pick-and-place assembly can pass above or below said vacuum nozzles of at least one other said pick-and-place assembly.

12. A high-speed linear pick-and-place of claim 11 wherein said vertical actuator means is a stationary electric motor and transmits mechanical motion to said vacuum nozzle by way of a bar or rod at least 5 inches in length which can be moved normal to its axis and to which said vacuum nozzle is linked mechanically via a wheel that contacts said bar or rod and rolls on said bar or rod such that the height of said vacuum nozzle can be adjusted while said vacuum nozzle is in a variety of horizontal positions.

13. A high-speed linear pick-and-place of claim 11 wherein horizontal actuator means comprises a linear motor utilizing stationary magnets wherein two or more said subassemblies share common magnets.

14. A high-speed linear pick-and-place of claim 11 wherein said electronic controller means operates said actuators to so that the path of pairs of said vacuum nozzles travel in substantially the same circuit unless device sorting is required.
